(19) United States
(12) Patent Application Publication
(10) Pub. No.: US 2015/0053848 A1
(43) Pub. Date: Feb. 26, 2015

(54) Identifying and Correcting Hogel and Hogel Beam Parameters

(71) Applicant: Zebra Imaging, Inc., Austin, TX (US)

(72) Inventor: Keith Alan Gardner, Ankeny, IA (US)

(73) Assignee: ZEBRA IMAGING, INC., Austin, TX (US)

(21) Appl. No.: 13/970,739

(22) Filed: Aug. 20, 2013

(51) Int. Cl. G03H 1/22

(52) U.S. Cl. CPC G03H 1/2249
USPC 250/226; 250/216

(57) ABSTRACT

Systems and methods include determining whether a parameter of a hogel beam, from a set of hogel beams, is within one or more thresholds. The one or more thresholds are based at least in part on one or more parameters of a first set of hogel beams. In response to the parameter being outside of the one or more thresholds, new values are determined for the parameter based at least in part on one or more parameters from a second set of hogel beams.

### A. BACKGROUND

The invention relates generally to the field of verifying and/or correcting hogel and/or hogel beam parameters.

For various reasons, calibration of a hogel light modulator may not yield the desired results for values of the parameters of the hogels and/or hogel beams generated by the hogel light modulator. For example, the presence of dust on the optics during the calibration process may interfere with the correct calibration of one or more hogel beams or hogels. Alternative verification and correction processes for values of the parameters of the hogel beams and/or hogels would therefore be desirable.

### B. SUMMARY

In some implementations, a method includes determining whether at least a subset of parameters of a hogel beam, from a set of hogel beams, is within one or more thresholds. The one or more thresholds are based at least in part on one or more parameters of a first set of hogel beams. In response to the subset of parameters being outside of the one or more thresholds, new values for the subset of parameters are determined based at least in part on one or more parameters from a second set of hogel beams.

In other implementations, a system includes one or more processing units and one or more memory units coupled to the one or more processing units. The system is configured to determine whether at least a subset of parameters of a hogel beam, from a set of hogel beams, is within one or more thresholds. The one or more thresholds are based at least in part on one or more parameters of a first set of hogel beams. In response to the subset of parameters being outside of the one or more thresholds, new values for the subset of parameters are determined based at least in part on one or more parameters from a second set of hogel beams.

In yet other implementations, a computer program product embodied in a non-transitory computer-readable medium includes logic instructions. The logic instructions are effective to determine whether at least a subset of parameters of a hogel beam, from a set of hogel beams, is within one or more thresholds. The one or more thresholds are based at least in part on one or more parameters of a first set of hogel beams. In response to the subset of parameters being outside of the one or more thresholds, new values for the subset of parameters are determined based at least in part on one or more parameters from a second set of hogel beams.

Numerous additional embodiments are also possible.

### C. BRIEF DESCRIPTION OF THE DRAWINGS

Other objects and advantages of the invention may become apparent upon reading the detailed description and upon reference to the accompanying drawings.

FIG. 1 is a block diagram illustrating a system configured to detect and correct errors in values of the parameters of hogel beams/hogels, in accordance with some embodiments.

FIG. 2 is a block diagram illustrating examples of detecting questionable parameters for hogels and/or hogel beams, in accordance with some embodiments.

FIG. 3 is a block diagram illustrating examples of correcting parameters for questionable hogel beams and/or hogels through interpolation using parameters of acceptable hogel beams and/or hogels, in accordance with some embodiments.

FIG. 4 is a flow diagram illustrating a method for detecting and correcting questionable parameters of hogel beams and/or hogels, in accordance with some embodiments.

FIG. 5 is a flow diagram illustrating a method for detecting questionable parameters of hogels, in accordance with some embodiments.

FIG. 6 is a flow diagram illustrating an iterative method for correcting questionable parameters of hogels, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### D. DETAILED DESCRIPTION

In some embodiments, systems and methods are disclosed for detecting and/or correcting errors in the calibration of the parameters of one or more hogel beams/hogels. The hogel beams/hogels may be generated by a hogel light modulator (or holographic/hogel display). A hogel light modulator is generally configured to generate a complex light field emerging from a holographic surface (or hogel surface) and accordingly generate full (or half, in some embodiments) parallax, auto-stereoscopic 3D images. In some embodiments, the light field may be approximated by hogel beams, uniform, cylindrical beams of light that originate from a certain spatial location on the holographic surface and travel in a certain direction at given phi and theta angles away from the holographic surface. The hogel beams generally each have unique color and intensity values, such as unique values for the colors red, green, and blue, for example.

In some embodiments, the hogel beams may be grouped into hogels according to the spatial location on the holographic surface from where the hogel beams originate. Accordingly, the hogel light modulator may include an array of hogels where each hogel is the originating point of a group of hogel beams, each headed in a different direction in space. In implementations where color hogel light modulators are involved, in each direction there may be red, green, and blue hogel beams of different intensities or other color types depending on the type of the color display.

For additional discussion on hogel rendering, please see U.S. Pat. No. 6,366,370, filed Apr. 2, 2002, entitled “RENDERING METHODS FOR FULL PARALLAX AUTOSTEREOSCOPIC DISPLAYS” and naming Mark Holzbach, et al. as inventors. The above-referenced patent application is hereby incorporated by reference herein in its entirety.

For more information on hogel displays or hogel light modulators, please see:

U.S. patent application Ser. No. 12/258,438, filed 26 Oct. 2008, titled “Systems and Methods for Calibrating a Hogel Display,” and naming Mark E. Lucente as inventor,

U.S. patent application Ser. No. 11/834,005, filed Aug. 5, 2007, titled “DYNAMIC AUTOSTEREOSCOPIC DISPLAYS,” and naming Mark E. Lucente et al. as inventors, and

U.S. patent application Ser. No. 11/724,832, filed Mar. 15, 2007, titled “DYNAMIC AUTOSTEREOSCOPIC DISPLAYS,” and naming Mark E. Lucente et al. as inventors.

The above-referenced patents and/or patent applications are hereby incorporated by reference herein in their entirety.

It should be noted that in certain cases there may not exist discretely discernible hogel beams for certain types of hogel light modulators. Hogel beams, as used here, however, may still be defined as discrete approximations of the generated continuous light field. For example, for certain types of hogel light modulators, hogels may be generated using an interference pattern and thus yield a continuous field of light from each hogel. In such cases, hogel beams may still be defined by the value (or the average value within a certain angular range) of the color and intensity observed in a certain direction from the hogel.

In some embodiments, values of intensity and color for each hogel beam may be associated with four parameters: two for representing the hogel beam's originating location on the holographic surface and two more for representing the direction in which the light beam is directed. Each hogel may be thought of as emitting a group of “hogel beams” (or generally a hogel light field) emerging from the hogel and travelling in different directions in space. Two parameters may define the spatial location of the hogel on the 2D hogel surface and two angular parameters may define a particular hogel beam of light emerging from the hogel. By being able to control the color and intensity of light in different directions emerging from multiple hogels, auto-viewable 3D images may be generated. In some embodiments, the auto-viewable 3D images can be experienced without additional equipment, such as special eyewear, and without the position of the eyes being required.

Hogel and hogel beam parameters may include any parameter that may be used to define the hogel or hogel beam. For example, such parameters may include, the coordinates indicating the location of the origination of a hogel beam (also the location of the center of the corresponding hogel), the direction (in phi and theta) in which the hogel beams travel, the intensity values for red, green, and blue values for each hogel beam, etc.

It should also be noted that images having less than full parallax may also be generated, such as images having horizontal, uni-directional, fractional, non-uniform, etc. parallax, for example. Images having no parallax may also be generated, such as images displaying different/distinct images at different angular views.

It should also be noted that the 2D holographic surface may be of any shape such as flat, concave, convex, spherical, etc. as well as any 2D manifold—a 2D surface of essentially any shape (such as a piece of cloth).

It should further be noted that color and intensity may refer to values of the three primary colors red, green, and blue (which may be used to represent different hues of color) but may also refer to a wavelength value or a spectrum (sum) of wavelength values of varying intensity or a combination of these.

It should further be noted that though hogel spatial locations may be specified using two parameters—when the hogel surface is known, for example—in some embodiments, the spatial location of the hogels (or of each individual hogel beam as required) may be specified using three spatial parameters.

In some embodiments, the hogel display is configured to receive and convert 3D data to hogel data, which may then be used by the hogel display to produce a 3D image. Hogel data may be a 4D array of color and intensity values—two parameters designating spatial location and two parameters designating angular direction from each location as described above. The 3D data may be presented in a variety of different formats and may be generated by a variety of applications. The 3D data may be generated, for example, by scans of real world scenery or objects or the 3D data may be generated by a computer.

In some embodiments, hogel data may be initially generated according to expected hogel positions, expected hogel beam directions, and expected color intensity response for a hogel light modulator. Initially and prior to any calibration to provide particular information about the hogel light modulator, it may be assumed that hogel positions follow a certain pattern, such as a regular grid of a given spacing. Similarly, it may be assumed that the directions of hogel beams for each hogel also follow a certain pattern as well. In addition, it may be assumed that all of the hogel beams exhibit substantially similar color intensity responses.

However, due to construction variations, variations in materials, variations in parts, etc. as well as other general equipment limitations (such as optical limitations), the positions, directions, and color responses of the hogel beams may vary from those expected values. Therefore, calibration may be performed to identify the particular characteristics of each hogel light modulator. In some embodiments, using various methods, an attempt may be made to determine the device, actual positions of the hogel beams (or hogels), the actual directions of the hogel beams, the actual color responses, etc. through one or more calibration processes.

In some embodiments, calibration may not yield optimal results for various reasons. In some embodiments, one or more of the parameters (spatial, angular, color response, etc., for example) of the hogels and hogel beams may be statistically compared to each other using various methods to identify one or more questionable parameters. Various corrections may then be applied to correct those questionable parameters.

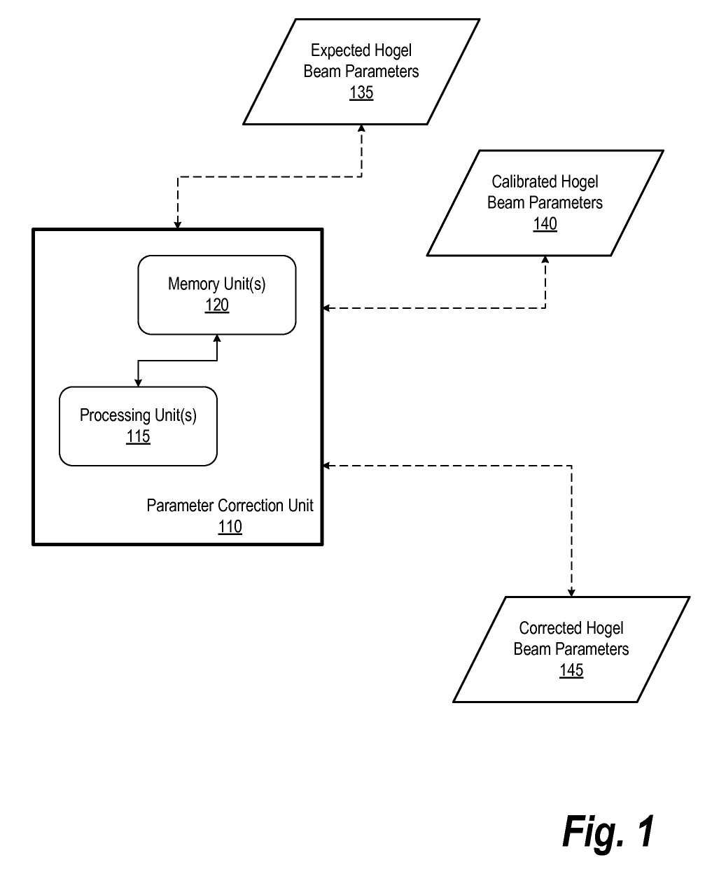

FIG. 1 is a block diagram illustrating a system configured to detect and correct errors in values of the parameters of hogel beams/hogels, in accordance with some embodiments.

In some embodiments, parameter correction unit 110 is configured to detect and correct errors with one or more parameters of one or more hogels and/or hogel beams of a hogel light modulator. Parameter correction unit 110 may include one or more processing units 115 and one or more memory units 120 coupled to processing units 115. Processing units 115 and memory units 120, optionally with additional units, are configured to implement the functionality of parameter correction unit 110.

In some embodiments, parameter correction unit 110 may be coupled to the expected hogel beam parameters 135 database. These parameters for the hogel beams and/or hogels represent the ideally expected parameter values for those positions, directions, and color responses assuming ideal, error-free equipment for the hogel light modulator. In some embodiments, the expected originating locations for the hogel beams may follow a certain pattern, such as a regular grid at the holographic surface, the expected directions for hogel beams may similarly follow a certain pattern, and the color responses may be assumed to be substantially equal across all of the hogel beams.

In some embodiments, parameter correction unit 110 may be coupled to the calibrated hogel beam parameters 140. These parameters for the hogel beams and/or hogels may represent the values of the parameters after the hogel light modulator was calibrated. Generally, calibration is intended to compensate for imperfections, etc. in the hogel light modulator that cause discrepancies from the expected values.

For various reasons, however, the calibration process may not yield the desired results. For example, in embodiments where a camera may be used as a light detector during the calibration process, a physical obstruction (such as dust) may prevent light from reaching the camera causing undesired calibration results.

In other embodiments, hogels/hogel beams located at the edge of the hogel light modulator (or at the edge of tiles that make up a hogel light modulator) may only receive a portion of the hogel data. As a result, the portion being used in the calibration process (the normal hogel beam, for example) may not be active, again resulting in questionable calibration results.

In yet other embodiments, if lenses are used as part of the hogel light modulator, specular anomalies in the lenses may cause the calibrated parameters for the red, green, and blue colors to be significantly different from each other. In such embodiments, lenses that are not glued flat may cause focusing issues and intensity uniformity issues, which may also cause calibration issues.

In some embodiments, parameter correction unit 110 may be configured to analyze parameters for hogels and/or hogel beams—such as calibrated hogel beams parameters 140—in order to determine one or more questionable parameters resulting from the calibration. In some embodiments, parameter correction unit 110 may compare one or more of the parameters to one or more of the other parameters in the set to determine one or more parameters with values that are outside certain threshold values. In some embodiments, the threshold value(s) may be computed by comparing the parameters together. Generally, various statistical methodologies may be applied to determine appropriate threshold values to apply in identifying the questionable parameters.

As the components used in a hogel light modulator are generally similar and the hogel light modulator is generally constructed using similar procedures, in some embodiments, the parameters for the generated hogels and/or hogel beams are expected to occur in certain patterns, which are often repeatable and/or regular. For example, in embodiments where sheets of lenslets on a regular grid are used as part of the optics, it is expected that the locations of the generated hogels are also substantially on a regular grid. Similarly, if the hogel beams are formed using pixels behind the lenslets, where the pixels are in a substantially regular grid, it is expected that the generated hogel beams also for a substantially regular grid when projected on a flat surface. In addition, for color displays, the parameters for the three colors (such as the hogel centers) are expected to have values that are approximately the same as the color responses for the various hogel beams are expected to have the approximately the same response.

Accordingly, in some embodiments, the parameters for the hogels and/or hogel beams may be compared to each other using various statistical methodologies, for example, in order to determine which of the parameter values are outside certain thresholds. In one implementation, the parameters for the red, green, and blue color centers of a hogel may be compared to each other. The hogel may be then labeled as questionable, for example, if any two of the color centers are at a distance from each other that is above a certain threshold distance. In some embodiments, the threshold distance may be determined (or approximated) by investigating a certain number of such distances across a group of hogels.

In another implementation, a distribution from all the center locations may be formed. The distribution, for example, may be of the distance of each calibrated hogel center from the hogel's expected center. In an ideal environment with nearly perfect equipment, the calibrated hogel centers will be located at or close to the expected hogel centers. Thus, in an ideal environment, the distances for all hogel centers from their expected values are zero. Accordingly, after forming the distribution for hogel center distances, a calibrated hogel center may be labeled as questionable if the hogel center distance is outside a certain threshold. In some embodiments, the threshold value may be expressed in terms of a multiple of the standard deviation of the distribution.

In embodiments where the hogel light modulator is assembled using multiple tiles placed together, a different distribution may be formed for each of the tiles. Accordingly, the determination that certain of the hogels are questionable may be performed separately for each tile and corresponding distribution.

In yet another implementation, a similar procedure may be applied to the angular distribution of hogel beams for a particular hogel. In such embodiments, the calibrated angular directions for the hogel beams are expected to be on an angular grid as projected on a flat surface. Alternatively, it is expected that the tangent of the angles of the directions of the hogel beams form a regular grid. Accordingly, questionable hogel beams may be identified by comparing the direction of a hogel beam to the direction of one or more other hogel beams (within the same hogel or across multiple hogels).

It should be noted that various other implementations may be used in order to identify questionable parameters in addition to the examples provided above.

In some embodiments, parameter correction unit 110 may be additionally configured to compute new parameter values for the parameters of the hogel beams and/or hogels that were identified as questionable. In some embodiments, parameter correction unit 110 may be configured to compute new parameters for the questionable parameters using one or more parameter values from one or more already acceptable neighboring hogel beams and/or hogels.

In one implementation, for example, parameter correction unit 110 may be configured to compute new parameters for questionable hogel centers by using at least four acceptable neighbors of a questionable hogel. In such implementations, hogel centers are assumed to form an expected pattern, such as a substantially regular grid. In such embodiments, the four acceptable neighbors may include pairs that can be, for example: above and below the questionable hogel, to the left and right of the questionable hogel, diagonally across from the questionable hogel, etc. In cases where at least four such acceptable neighbors do not exist for a particular hogel, parameter correction unit 110 may be configured to delay the computation of new parameters until a later time for that particular hogel. For example, the computation of new parameters for that hogel

In cases where at least such four acceptable neighbors do exist, parameter correction unit 110 may be configured to compute new parameters (such as the hogel locations in this example) by finding the intersection of lines formed by the pairs of acceptable neighbors. For example, a first line may be formed between the hogel above and the hogel below the questionable hogel, and a second line may be formed between the hogel to the left and the hogel to the right of the questionable hogel. The new location for the center of the hogel may then be the point where the two lines intersect.

In embodiments where additional pairs of acceptable hogels are used (assuming such acceptable pairs exist), additional lines may be formed giving rise to additional points of intersection. For example, if three pairs are used giving rise to three lines, three intersection points are formed, one for each pair of lines. The new hogel center parameters may then be determined, for example, by averaging the location of the three intersection points.

In embodiments where a color hogel light modulator is used, the above process may be separately applied to each of the three colors red, green, and blue.

In some embodiments, second degree (or higher) neighbors may also be used as part of the interpolation process. In yet other embodiments, methods that are more elaborate may be implemented. For example, higher order neighbors may be used (two, three, or higher), where the neighbors are given an exponentially decreasing weight according to the order of each neighbor or alternatively the distance from the acceptable hogel to the questionable hogel. Various other statistical methods may be used.

In some embodiments, parameter correction unit 110 may be configured to detect and correct issues with the calibration of the color response of a hogel light modulator. In some embodiments, it is expected that all of the hogels/hogel beams for a hogel light modulator (or at least those within a tile of a hogel light modulator or other such groupings) will have the same color response. At a first order, the calibration of the color response may be performed by applying a scaling factor to color values provided to each of the hogel beams. For example, it may be determined that in order to calibrate the values for the red color of a certain hogel beam, the values are to multiplied by 1.15 and that in order to calibrate the values for the red color of another hogel beam, the values are to multiplied by 0.98, etc.

In some embodiments, questionable color response parameters may be then identified in response to determining that the scaling factor for a certain color of a certain hogel beam is outside of a certain threshold or a certain threshold range. In some embodiments, the threshold or threshold range may be determined by examining a distribution of the color response from a group of hogel beams.

In some embodiments, questionable color response parameters may be corrected from values from one or more neighboring parameters by using one or more of the interpolating methods described here.

In some embodiments, after a first iteration of determining new parameters for one or more questionable hogels/hogel beams, additional questionable hogel and hogel beam parameters may remain. Accordingly, additional iterations may be implemented in order to attempt to find new parameters for the remaining questionable hogels. In some embodiments, in subsequent iterations, previously questionable parameters that have been corrected with new values may be included in the pool of acceptable parameters. Accordingly, parameters that were not correctable during previous iterations (due to lack of sufficient acceptable nearest neighbors) may be correctable now as a higher number of acceptable parameters is present.

In some embodiments, the iterations may continue until no more parameters are changing from questionable to acceptable or until a maximum number of iterations has occurred, for example. In some embodiments, after the completion of the iterations, any remaining questionable parameters may be reset to their initial, pre-calibration values—the theoretical/expected values for the parameters. Alternatively, any remaining questionable parameters may be kept at their current values. In yet other embodiments, at higher iterations the conditions for calculating new values for parameters of questionable hogels/hogel beams may be changed such that it is now less restrictive to calculate new parameters for questionable parameters. For example, less than four acceptable neighbors may be required to compute the new parameter values.

In some embodiments, parameter correction unit 110 may be configured to store the corrected hogel beam parameters in corrected hogel beam parameters 145 database.

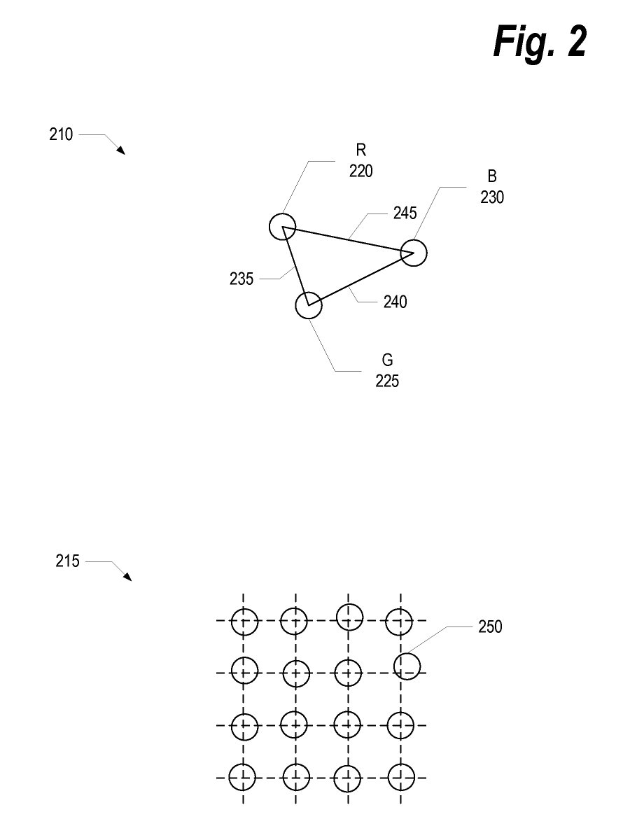

FIG. 2 is a block diagram illustrating examples of detecting questionable parameters for hogels and/or hogel beams, in accordance with some embodiments.

Example 210 is one example of how it may be determined that the location coordinates for a certain hogel are questionable. In this implementation, the calibrated hogel location centers for red, green, and blue may be compared to each other to evaluate the location coordinates of a hogel. A hogel's location may be designated as questionable if any pairs of the red, green, and blue location centers are at distances apart that are beyond certain thresholds.

In example 210, red R 220 represents the location center for the red color, green G 225 represents the location center for the green color, and blue B 230 represents the location center for the blue color. In some embodiments, to determine whether a hogel's location coordinates are to be considered questionable, the distances between pairs of the location of the three color centers of a hogel are examined. In one implementation, for example, a hogel may be designated as questionable in response to determining that any of the three distances 235, 240, and 245 (the distances between pairs of the color centers) are greater than a certain threshold distance. Alternatively, the average of the three distances may be compared to the threshold distance.

Example 215 is another example of how it may be determined that the location coordinates for a certain hogel are questionable. In this implementation, the hogel location calibrated coordinates are represented by the circles shown on the grid. The grid locations represent the originally expected hogel locations (the locations of the hogel centers before calibration was applied). In some implementations, an average may be computed for the distance between the expected hogel centers and the calibrated hogel centers. For example, the radial distance for each original-calibrated hogel center may be determined, and then the average and standard deviation of all the radial distances may be computed. Accordingly, a hogel may be then designated as questionable in response to determining that the radial distance for the particular hogel center is greater than a threshold radial distance, where the threshold distance may be based on the previously computed average/standard deviation.

It should be noted that various other methods may be implemented in determining whether a hogel center is to be labeled questionable based on one or more other coordinates from the hogel or other hogels.

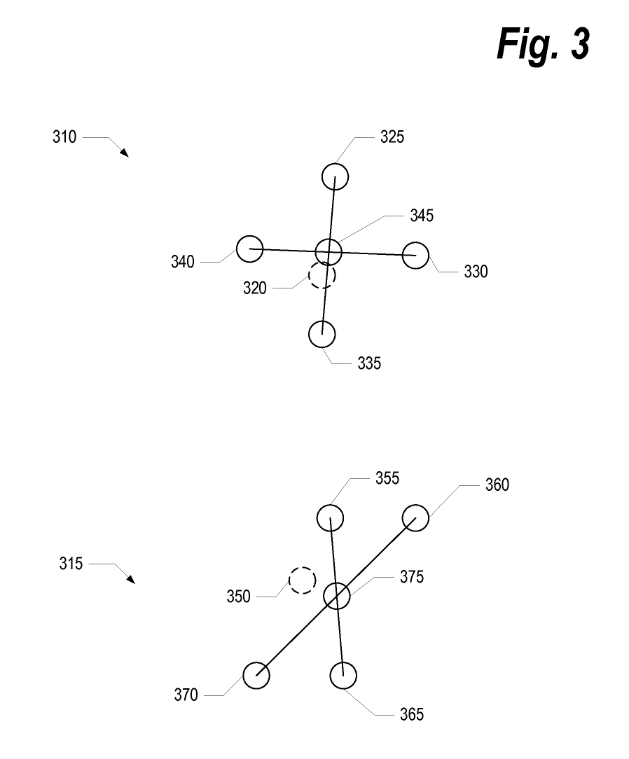

FIG. 3 is a block diagram illustrating examples of correcting parameters for questionable hogel beams and/or hogels through interpolation using parameters of acceptable hogel beams and/or hogels, in accordance with some embodiments.

Example 310 is one example on how new location coordinates for a questionable hogel may be determined. In this implementation, new location coordinates for the questionable hogel are generated using coordinates from one or more acceptable hogel location coordinates. A variety of methods may be used to implement this determination.

In example 310, location 320 represents the questionable location of a hogel, as may be derived from previous calibrations, for example. In some embodiments, locations 325, 330, 335, and 340 represent the locations of hogels that were determined to be acceptable. In this example, the new coordinates for the questionable hogel may be computed by interpolating using the locations of the acceptable hogels. For example, a first straight line may be drawn between location 325 and location 335, and a second line may be drawn between location 330 and location 340. In this example, the intersection of the first and second lines, location 345, provides the new and corrected location for the questionable hogel.

Example 315 is another example on how new location coordinates for a questionable hogel may be determined. In example 315, location 350 represents the original, questionable location of a hogel. In some embodiments, locations 355, 360, 365, and 370 represent the locations of hogels that were determined to be acceptable. It should be noted that two of the locations for the acceptable hogels in this example are located along a diagonal with respect to the questionable hogel.

In this example, the new coordinates for the questionable hogel may be again computed by interpolating using the locations of the acceptable hogels. For example, a first straight line may be drawn between location 355 and location 365, and a second line may be drawn between location 360 and location 370. The intersection of the first and second lines, location 375, again provides the new and corrected location for the questionable hogel.

It should be noted again that various other methods may be implemented for determining new coordinates for a questionable hogel using acceptable coordinates from other hogels and/or from the questionable hogel.

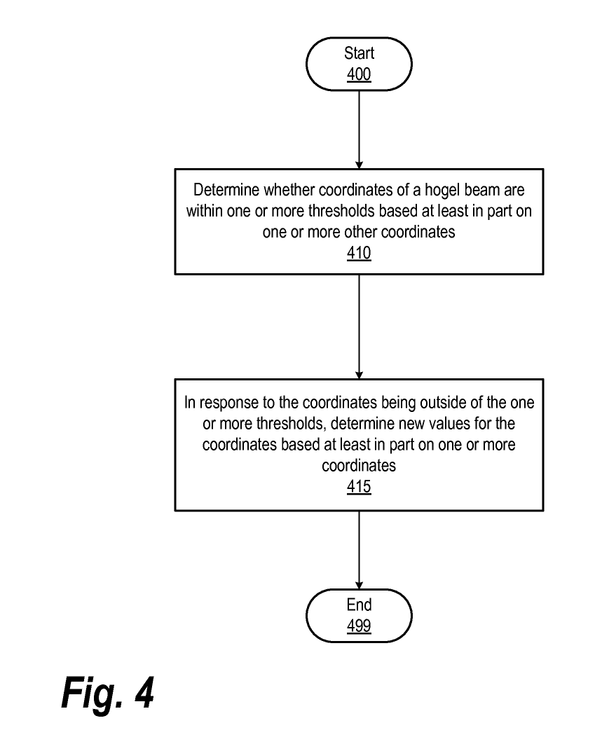

FIG. 4 is a flow diagram illustrating a method for detecting and correcting questionable parameters of hogel beams and/or hogels, in accordance with some embodiments.

Processing begins at 400 where, at block 410, a determination is made as to whether parameters of a hogel beam are within one or more thresholds based at least in part on one or more other parameters. The other parameters may be parameters of the hogel beam or they may be parameters from other hogel beams.

At block 415, in response to the parameters being outside of the one or more thresholds, new values for the parameters are determined based at least in part on one or more parameters. The one or more parameters may be parameters of the hogel beam or they may be parameters from other hogel beams.

Processing subsequently ends at 499.

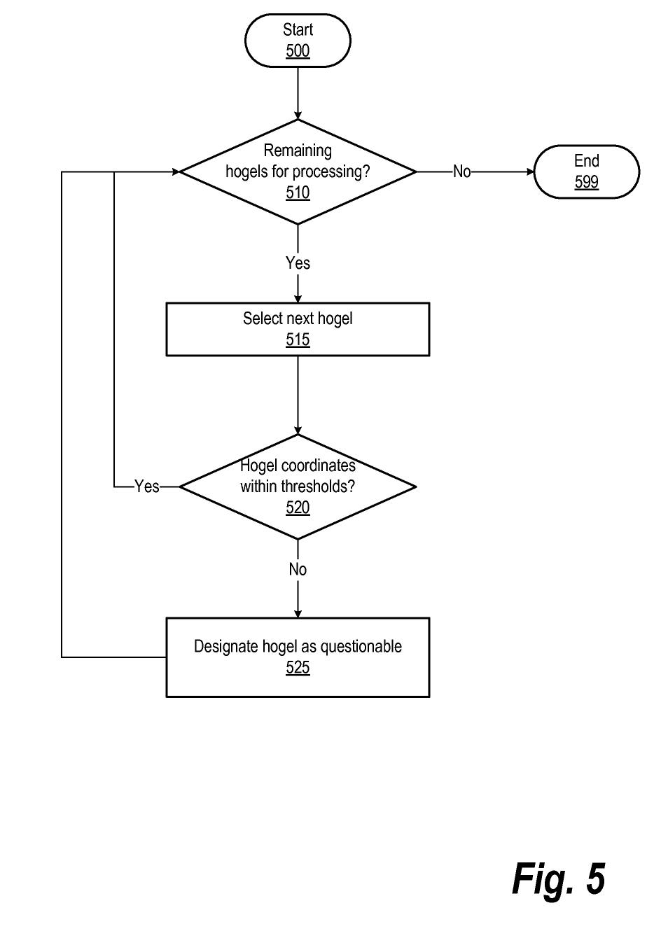

FIG. 5 is a flow diagram illustrating a method for detecting questionable parameters of hogels, in accordance with some embodiments.

In some embodiments, the functionality described here may be implemented by one or more of the systems shown in FIG. 1. In some embodiments, the functionality described here may correspond to the functionality described in block 410 of FIG. 4.

In some embodiments, an example for detecting questionable coordinates for hogel beams and/or hogels is presented. In this example, the location coordinates of one or more hogels of a hogel light modulator are examined to determine whether these coordinates are within certain thresholds. In some embodiments, the hogel location coordinates being evaluated are the result of a calibration process that was previously performed on a hogel light modulator.

Processing begins at 500 where, at decision 510, a determination is made as to whether additional hogels remain for processing. In some embodiments, the system may be configured to examine the coordinates of at least a subset of the hogels of a hogel light modulator to determine whether the coordinates are within certain thresholds. If there are no hogels remaining for processing, decision 510 branches to the “no” branch where the processing ends at 599.

On the other hand, if additional hogels remain for processing, decision 510 branches to the “yes” branch where, at block 515, the next hogel is selected for processing. At decision 520, a determination is made as to whether the hogel location coordinates are within certain thresholds. In some embodiments, the hogel location coordinates may be compared to other hogel location coordinates to determine whether the coordinates are within certain thresholds. In other embodiments where a color hogel light modulator is used, for example, a hogel's location coordinates for red, green, and blue colors may be compared to each other. In such embodiments, a hogel may be considered questionable, for example, if any two pairs of color centers are at a distance from each other that is higher than a certain threshold distance. Alternatively, a hogel may be labeled as questionable if the average distance between pairs of color centers is above a certain threshold distance.

If the hogel's location coordinates are within the imposed thresholds, decision 520 branches to the “yes” branch where another determination is made, at decision 510, as to whether additional hogels remain for processing.

On the other hand, if the hogel coordinates are not within the imposed thresholds, decision 520 branches to the “no” branch where, at block 525, the hogel is designated as questionable. Processing subsequently returns to 510 where again another determination is made, at decision 510, as to whether hogels remain for processing.

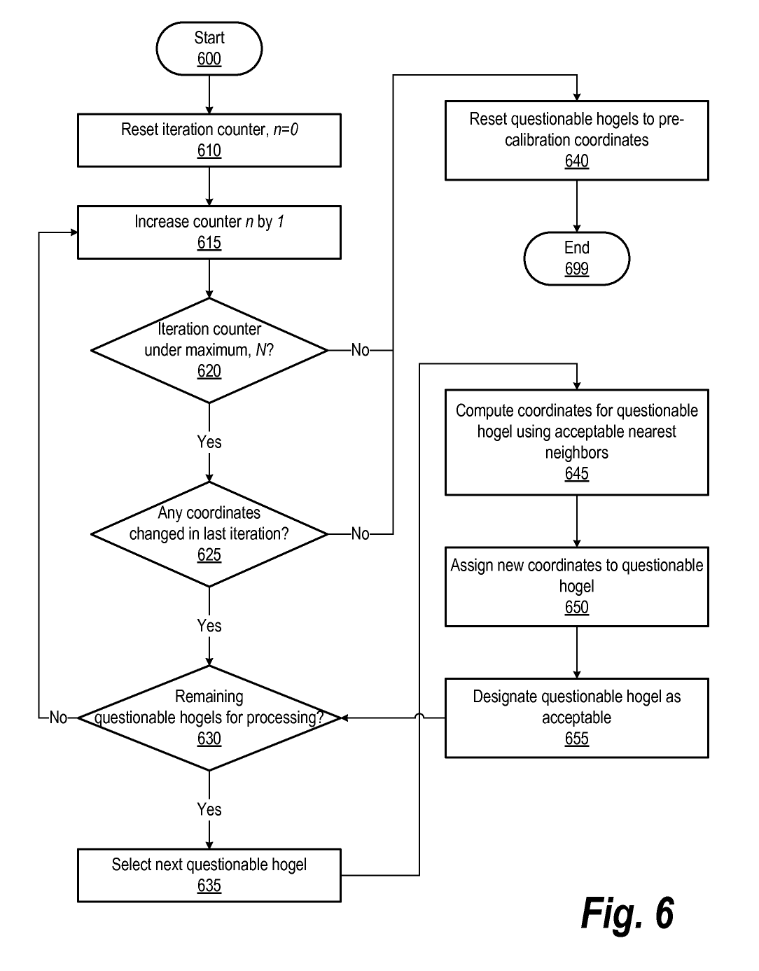

FIG. 6 is a flow diagram illustrating an iterative method for correcting questionable parameters of hogels, in accordance with some embodiments.

In some embodiments, the functionality described here may be implemented by one or more of the systems shown in FIG. 1. In some embodiments, the functionality described here may correspond to the functionality described in block 410 of FIG. 4.

In some embodiments, the method described here is one example of correcting questionable coordinates for hogel beams and/or hogels. In this example, the location coordinates of questionable hogels of a hogel light modulator are being corrected.

Processing begins at 600 where, at block 610, the iteration counter, n, is set to zero (n=0). The iteration counter may be used to track the number of iterations that the correction procedure has been applied to a particular set of hogels.

At block 615, the counter is increased by 1 (n=n+1), and subsequently, at decision 620, a determination is made as to whether the iteration counter is under a maximum iteration number, N. In some embodiments, if the iteration counter has reached the maximum preset number, decision 620 branches to the “no” branch where processing continues at block 640.

At block 640, any remaining questionable hogels' location coordinates are reset to the initial values. In some embodiments, the initial values of the locations of the hogels are the expected values of the hogel locations prior to the application of any calibration processes. Processing subsequently ends at 699.

On the other hand, if the iteration counter is under the maximum number of iterations, decision 625 branches to the “yes” branch where, at decision 630, another determination is made as to whether any hogel location coordinates were updated during the last iteration. In some embodiments, if there are no updates to any hogels during the last iteration, it is an indication that any additional iterations would not be useful, as the success of a subsequent iterations generally depends on a contributing change that occurred during the previous iteration.

If no coordinates have changed during the last iteration, decision 625 branches to the “no” branch where processing continues again at block 640. On the other hand, if there was a change in any hogel location coordinates during the last iteration, decision 625 branches to the “yes” branch where, at decision 630, another determination is made as to whether any questionable hogels remain for processing. If no questionable hogels remain, decision 630 branches to the “no” branch where processing returns to block 615 where the counter is increased by 1 and the next iteration begins.

On the other hand, if questionable hogels remain, decision 630 branches to the “yes” branch where, at block 635, the next questionable hogel is selected for processing. At block 645, new coordinates for the questionable hogel are computed using acceptable neighboring hogels. In some embodiments, four acceptable hogels may be used. The new location coordinates for the questionable hogel may then be computed by interpolating (or by other more complicated methods) using the location coordinates from the acceptable hogels.

At block 650, the new coordinates are assigned to the questionable hogel, and at block 655, the questionable hogel is designated as acceptable. Accordingly, the hogel may now be used for interpolations, etc. for other questionable coordinates during subsequent iterations.

Processing subsequently returns to decision 630 where another determination is made as to whether additional questionable hogels remain for processing.

One or more embodiments of the invention are described above. It should be noted that these and any other embodiments are exemplary and are intended to be illustrative of the invention rather than limiting. While the invention is widely applicable to various types of systems, a skilled person will recognize that it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To illustrate clearly this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations that follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method comprising identifying a questionable parameter of a hogel beam based at least in part on determining that the parameter is outside one or more thresholds, wherein the one or more thresholds are based at least in part on one or more parameters of a set of hogel beams.

2. The method of claim 1, wherein the parameter of the hogel beam resulted from a calibration process.

3. The method of claim 1, wherein the set of hogel beams comprises the hogel beam.

4. The method of claim 1, wherein the determining that the parameter of the hogel beam is outside one or more thresholds comprises determining that a distance between two of originating locations for a red, a green, and a blue color of the hogel beam is greater than a threshold distance.

5. The method of claim 1, wherein the one or more thresholds are computed using statistical calculations on the one or more parameters of the set of hogel beams.

6. A method comprising determining at least one new value for a questionable parameter of a hogel beam based at least in part on one or more parameters from a set of hogel beams.

7. The method of claim 6, wherein the one or more parameters from the set of hogel beams are acceptable.

8. The method of claim 6, wherein the determining at least one new value for the questionable parameter comprises applying statistical calculations to the one or more parameters.

9. A system comprising one or more processing units, the one or more processing units being configured to identify a questionable parameter of a hogel beam based at least in part on determining that the parameter is outside one or more thresholds, wherein the one or more thresholds are based at least in part on one or more parameters of a set of hogel beams.

10. The system of claim 9, wherein the parameter of the hogel beam resulted from a calibration process.

11. The system of claim 9, wherein the set of hogel beams comprises the hogel beam.

12. The system of claim 9, wherein the determining that the parameter of the hogel beam is outside one or more thresholds comprises determining that a distance between two of originating locations for a red, a green, and a blue color of the hogel beam is greater than a threshold distance.

13. The system of claim 9, wherein the one or more thresholds are computed using statistical calculations on the one or more parameters of the set of hogel beams.
